(19) United States
(12) Patent Application Publication
(10) Pub. No.: US 2026/0301720 A1
(43) Pub. Date: Oct. 1, 2026

(54) PEDALBOARD

(71) Applicants: Eric Werro, Untersiggenthal (CH); Benjamin Opderbecke, Untersiggenthal (CH)

(72) Inventors: Eric Werro, Untersiggenthal (CH); Benjamin Opderbecke, Untersiggenthal (CH)

(21) Appl. No.: 19/550,416

(22) Filed: Feb. 26, 2026

Related U.S. Application Data
(60) Provisional application No. 63/780,528, filed on Mar. 31, 2025.

(51) Int. Cl. G10H 1/32; G10G 7/00

(52) U.S. Cl. CPC G10H 1/32; G10G 7/005

(57) ABSTRACT

Modular pedalboard is provided that includes one or more pedalboard segments. Each of the pedalboard segments includes a metal base layer having electrically isolated electrical contacts/connectors positioned on vertical sides of the metal base layer and a series of openings through a horizontal surface of the metal base layer. An outer layer covers the horizontal surface of the metal base layer, partially surrounding the vertical sides of the metal base layer to leave exposed the electrical contacts/connectors, the outer layer having a mounting surface with an array of locating apertures and an array of wire management apertures that align with the series of openings in the underlying metal base layer, the locating apertures adapted to hold a mounting plate attached to a bottom surface of a pedal element or a foot pedal. A kit is also provided that includes the modular pedalboard and a modular and expandable carrying case therefor.

### RELATED APPLICATIONS

This application is a non-provisional application that claims priority benefit of U.S. Provisional Application Ser. No. 63/780,528, filed 31 Mar. 2025; the contents of which are hereby incorporated by reference.

### FIELD OF THE INVENTION

The present invention relates to music equipment, and more particularly to a modular pedalboard.

### BACKGROUND OF THE INVENTION

A pedal board is a board or frame that a musician may use to house, organize, and transport their effects pedals. The effect pedals held on a pedalboard are used to enhance the sounds made by an instrument connected to the pedalboard. A non-limiting example of an instrument used in conjunction with a pedalboard illustratively includes a guitar. The pedalboard makes it much easier for a musician, such as a guitarist, to use their collection of effects pedals without having to worry about repeatedly setting up and tearing down long and complex pedal chains every time they want to play. Pedalboards allow a user to better organize their pedal effects, as the order of different effects pedals have different effects on the signal sent through them, so the order in which pedals are organized will have a determinent effect on the sound ultimately produced. Furthermore, attaching effects pedals to a pedalboard also improves the use of pedals while playing. Pedal chains laid out on a floor are susceptible to sliding around and moving, which can make pressing down on foot pedals (stomp boxes) precisely when needed a challenge. An example of foot pedals laid out on a floor and susceptible to movement is shown in FIG. 1 with a number of loose cables connecting effect elements. Pedals mounted on a board, however, are fastened in place and stationery, making it known that the pedal to be hit is exactly where it is expected to be, even if a musician doesn't have the time to look down. FIG. 2 illustrates foot pedals mounted to a board; however, a number of cables are still exposed on the floor.

Pedalboards come in a wide variety of different shapes and sizes, which allows a musician to pick and choose or build a board that meets their needs. For example, while some guitar players may only need a small, simple board with enough room to place a few pedals, others may need more space to store larger collections of pedals, utilize effects loops, house integrated power supplies, and more. Examples of existing, prior art pedalboards are shown in FIGS. 3-5. FIGS. 3A-3C illustrate pedal elements 16 mounted to a board using hook and loop (Velcro™) where pedalboard 10 has rows 12 of hook and loop material 14 that mates with hook and loop material 14 adhesively applied to the bottoms of pedal elements 16 as shown in FIG. 3B. FIG. 3C illustrates a completed board with assorted pedal elements and foot pedals mounted to the board 10. FIG. 4 illustrates a prior art pedalboard 20 with a mounting surface 22 that has an array of locating apertures 24 and an array of wire management apertures 26. FIG. 5 illustrates an exploded view of a prior art pedal element 16 that attaches to the pedalboard 20 of FIG. 4. A mounting plate 28 with a series of mounting pins 30 adapted to fit the locating apertures 24 is adhered to a pedal element 16 with an applied adhesive pad 32. Following placement of the pedal element 16 on the mounting surface 22, a securement screw 34 locks the pedal element to the pedalboard 20.

While there are many types of pedalboards available there continues to be a need for improved pedalboards that offer integrated electrical connections between pedalboard sections, pedal elements on a section, as well as improved wire management. There further exists a need for modular pedalboards that are convenient to transport.

### SUMMARY OF THE INVENTION

A modular pedalboard is provided that includes one or more pedalboard segments. Each of the pedalboard segments includes a metal base layer having electrically isolated electrical contacts/connectors positioned on vertical sides of the metal base layer and a series of openings through a horizontal surface of the metal base layer. An outer layer covers the horizontal surface of the metal base layer, and partially surrounds the vertical sides of the metal base layer to leave exposed the electrical contacts/connectors, the outer layer having a mounting surface with an array of locating apertures and an array of wire management apertures that align with the series of openings in the underlying metal base layer, the locating apertures adapted to hold a mounting plate attached to a bottom surface of a pedal element or a foot pedal.

A kit is also provided that includes the modular pedalboard and a modular and expandable carrying case therefor.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a prior art pedalboard without cable management and unsecured foot pedals located directly on a floor;

FIG. 2 illustrates a prior art pedalboard without cable management and secured foot pedals located directly on the board;

FIGS. 3A-3C illustrates a prior art pedalboard with hook and loop attachment of pedal elements to the pedalboard and foot pedals attached to the pedalboard;

FIG. 4 illustrates a prior art pedalboard with a mounting surface that has an array of locating apertures and an array of wire management apertures;

FIG. 5 illustrates an exploded view of a prior art pedal element that attaches to the pedalboard of FIG. 4, with a prior art mounting plate with a series of mounting pins adapted to fit in the locating apertures, the mounting plate is adhered to a pedal element with an applied adhesive pad, and a securement screw locks the pedal element to the pedalboard via the mounting plate;

FIG. 6 illustrates a partial front perspective view of two pedalboard segments prior to being connected showing mating tabs and magnets and receptacles for a joining bracket in accordance with embodiments of the invention;

FIG. 7 illustrates a partial side perspective view of two pedalboard segments prior to being connected showing engagement pins, magnets, and electrical conductors in accordance with embodiments of the invention;

FIG. 8A illustrates a rear side perspective view of two pedalboard segments connected together prior to placement of the joining bracket in accordance with embodiments of the invention;

FIG. 8B illustrates a rear side perspective view of two pedalboard segments of FIG. 8A connected together and the joining bracket applied in accordance with embodiments of the invention;

FIGS. 9A-9C are perspective views showing a power supply distribution connector attachment to the side electrical conductors in accordance with embodiments of the invention;

FIG. 10 is an underside view of a pedalboard segment showing wire management conduits joined to a base layer of the pedalboard segment in accordance with embodiments of the invention;

FIGS. 11A and 11B are rear perspective views of two pedalboard segments having top layers in different colors and instrument connections and other electrical connections in accordance with embodiments of the invention;

FIG. 12A is a bottom side view of a mounting plate for pedal elements in accordance with embodiments of the invention;

FIG. 12B is a top side view of a mounting plate for pedal elements with adhesive strips for attachment to a bottom face of a pedal element in accordance with embodiments of the invention;

FIG. 13A and FIG. 13B illustrates examples of two sizes of pedal segments populated with pedal elements that may be joined together to form a larger pedalboard in accordance with embodiments of the invention;

FIG. 14 illustrates an example of the two different sized pedal segments of FIGS. 13A and 13B joined together with a foot pedal secured in the upper left side of the pedalboard assembly in accordance with embodiments of the invention; and

FIGS. 15A and 15B are perspective views of carrying cases for the pedalboard of FIG. 14.

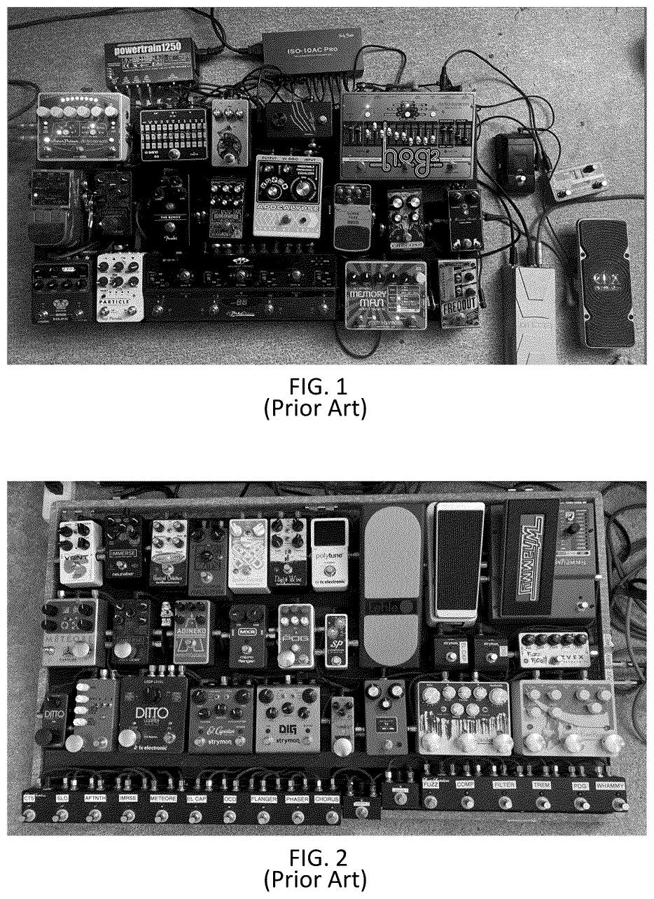

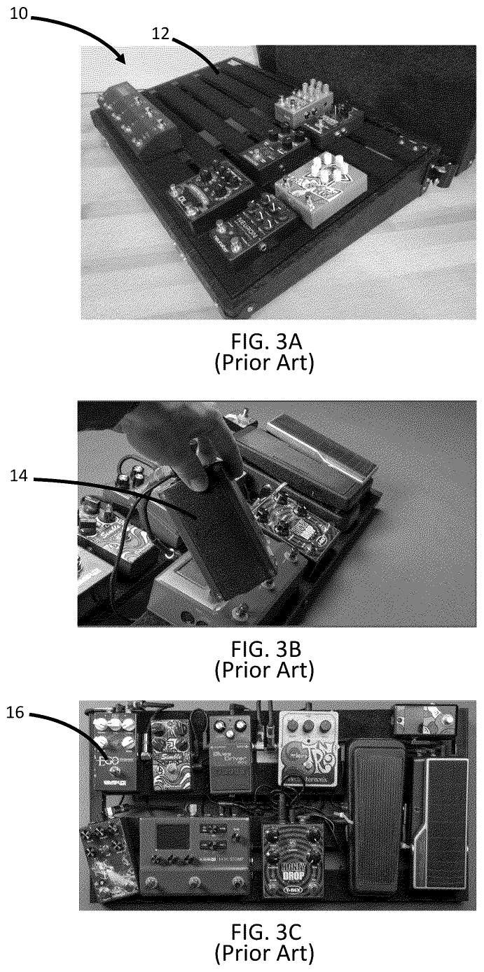

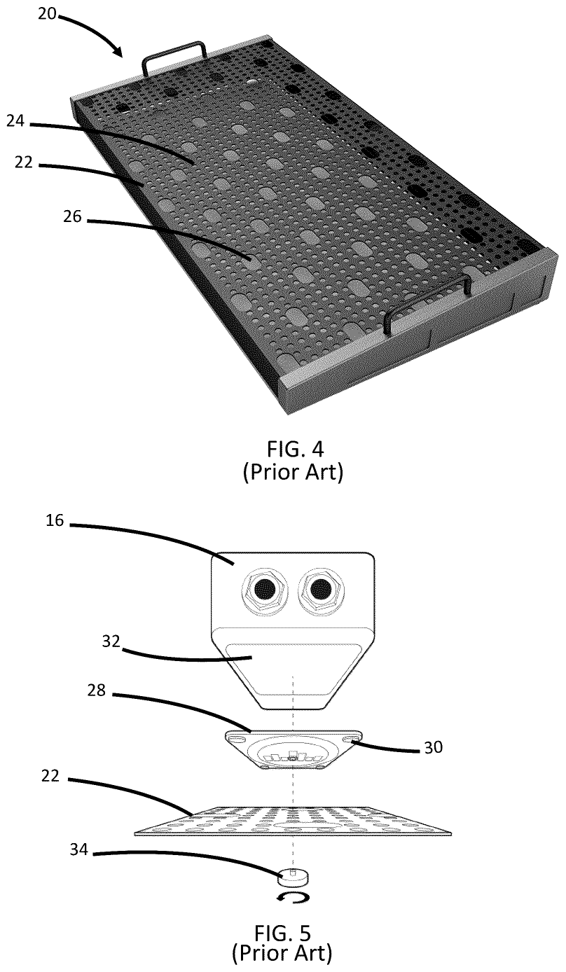

### DETAILED DESCRIPTION OF THE INVENTION

The present invention has utility as an expandable and modular pedalboard assembly that is expandable as the number of pedal elements needed in a setup increases. The modular assembly retains pedal elements and makes connections between pedalboard segments/sections as well as electrical connections between pedalboard segments without the use of screws. The connections are made via magnetic attraction between connectable elements. The electrical connections are built-into the pedalboard structure to route power and information signals between pedalboard segments. Wire management is provided in embodiments of the inventive modular pedalboard to route cables between pedal elements on the underside of the pedalboard in order to minimize exposed wiring. The use of magnetic connections, embedded electrical connections, and wire management allow for convenient and streamlined setup and ensure the integrity of a pedalboard assembly during transport.

Embodiments of the expandable and modular pedalboard assembly have pedalboard segments with a metal base layer having electrically isolated electrical contacts/connectors and an outer layer that covers and surrounds the metal base layer. The outer layer may be made of brushed aluminum, plastic, composite materials, or a combination thereof. The metal base layer provides connections for wire management conduits, electrical contacts/connectors, and has a series of openings for cables from the topside mounted pedal elements to be routed underneath the pedalboard assembly. The outer layer has a mounting surface that has an array of locating apertures and an array of wire management apertures that align with the series of openings in the metal base layer. Pedal elements attach to the pedalboard metal base layer with mounting plate with a series of mounting pins, which may be magnetic, that are adapted to fit in the array the locating apertures of the outer layer. The mounting plate is adhered to a pedal element with an applied adhesive pad, magnetic strip, or adhesive strips. It is appreciated that in some inventive embodiments, adhesives or magnets are selectively removable.

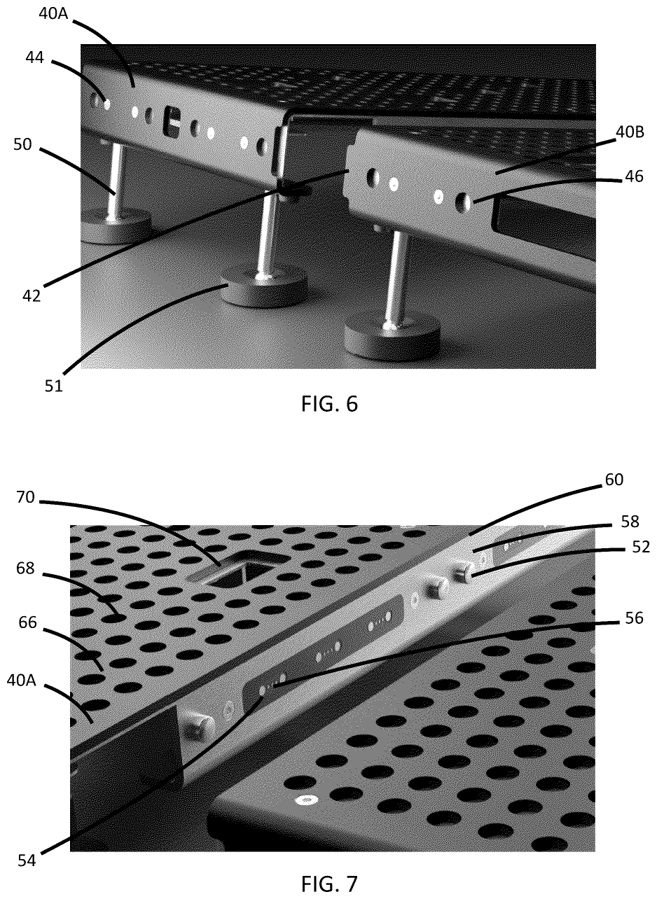

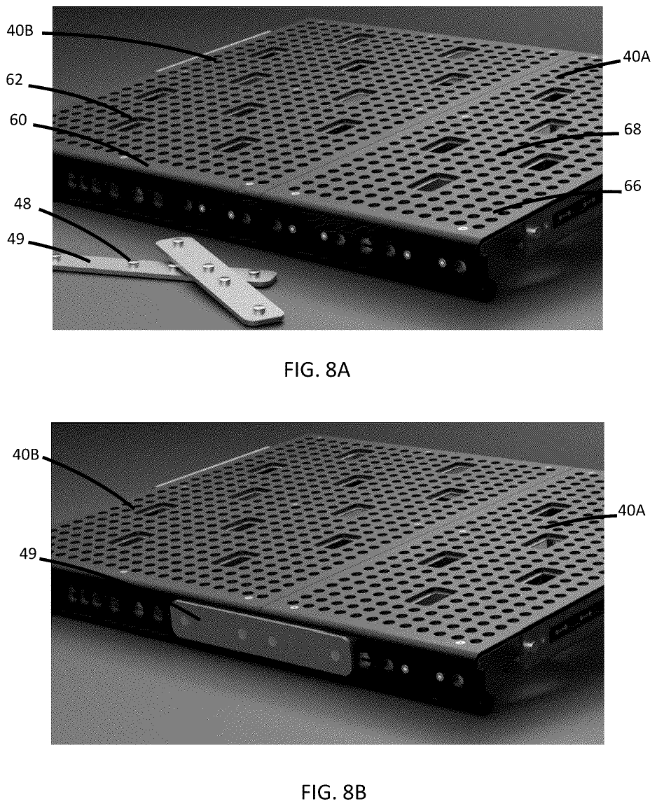

Referring now to the figures, FIG. 6 illustrates a partial front perspective view of two pedalboard segments (40A, 40B) prior to being connected showing mating tabs 42, and bracket magnets 44 and receptacles 46 for bracket pins 48 of a joining bracket 49 (see FIG. 8A). Support legs 50 and feet 51 provide a user adjustable placement angle for a pedalboard.

FIG. 7 illustrates a partial side perspective view of the two pedalboard segments (40A, 40B) prior to being connected showing side engagement pins 52, side magnets 54, and electrical conductors 56. The side engagement pins 52 protruding from pedalboard segment 40A mate up with corresponding pin receptacle on pedalboard segment 40B that are not visible from the views shown. The side engagement pins 52 may be magnetized. The attraction of the side magnets 54 and in specific embodiments the side engagement pins 52 serve to align and lock the pedalboard segments (40A, 40B) together when the pedalboard segments (40A, 40B) are brought in close proximity to each other. It is appreciated that additional pedalboard segments may be joined together to form an even larger pedalboard assembly with three or more segments. The electrical conductors 56 join to corresponding electrical conductors on an adjacent joined pedalboard segment (not shown) to form a completed electrical distribution of information signals and power between the joined pedalboard segments.

A metal base layer 58 contains the electrically isolated electrical conductor contacts/connectors 56 and is contained in an outer layer 60 that covers and surrounds the metal base layer 58. The outer layer 60 may be made of brushed aluminum, plastic, composite materials, or a combination thereof. As best shown in FIG. 10, the metal base layer 58 provides connections for wire management conduits 62 and has a series of openings 64 for cables from the topside mounted pedal elements to be routed underneath the pedalboard assembly. The outer layer 60 has a mounting surface 66 that has an array of locating apertures 68 and an array of wire management apertures 70 that align with the series of openings 64 in the metal base layer 58.

FIG. 8A illustrates a rear side perspective view of two pedalboard segments (40A, 40B) connected together prior to placement of the joining bracket 49. FIG. 8B illustrates a rear side perspective view of two pedalboard segments (40A, 40B) connected together and the joining bracket 49 applied. The magnetic attraction of the joining bracket 49 to magnets of the metal base layer 58 reinforce the union between the joined pedalboard segments (40A, 40B).

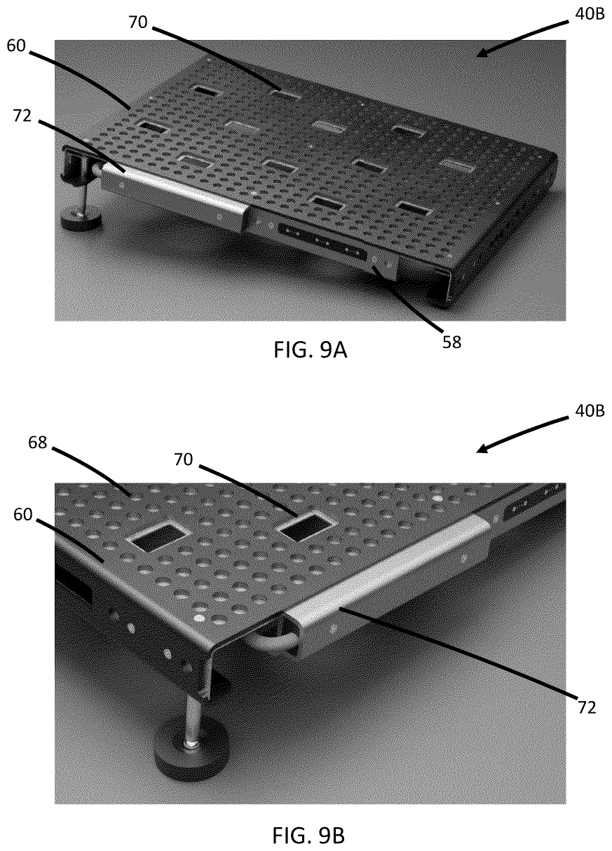

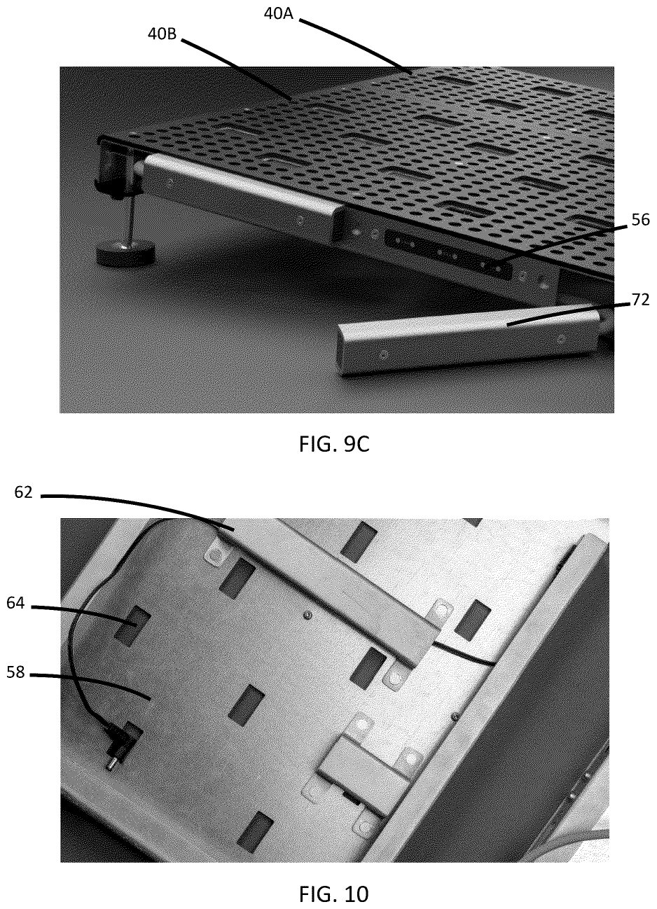

FIGS. 9A-9C are perspective views showing a power supply distribution connector 72 in relation to the side electrical conductors 56. A power supply distribution connector 72 routes power to multiple pedal elements via the separate electrical connections 56. The electrical connections 56 besides delivering power to pedal elements 16 may also distribute information signals to and from the pedal elements 16. The power supply distribution connector 72 is magnetically attracted to the electrical connections 56 that are positioned on the metal base layer 58.

FIG. 10 is an underside view of a pedalboard segment 40B showing wire management conduits 62 joined to a base layer 58, as well as series of openings 64 for cables from potential topside mounted pedal elements 16.

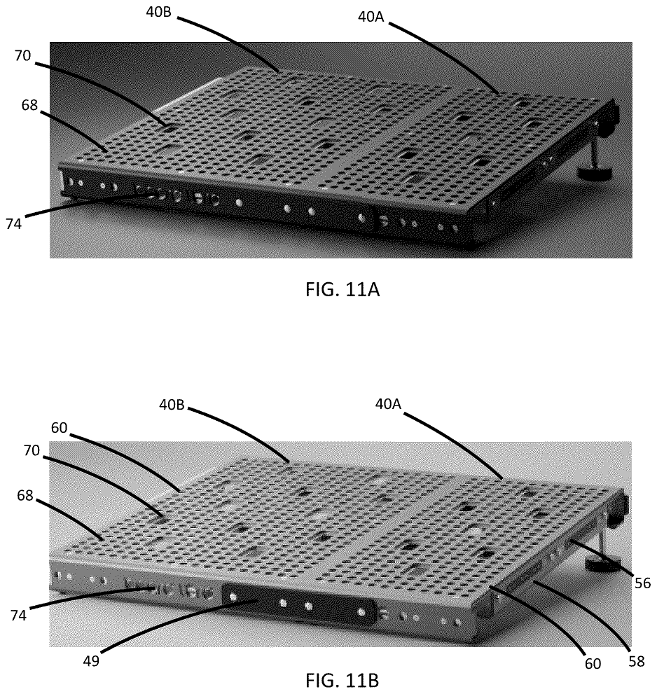

FIGS. 11A and 11B are rear perspective views of two joined pedalboard segments (40A, 40B) having top outer layers 60 in different colors and instrument connections 74 and other electrical connections including an external power source. As best shown in FIG. 11B, a joining bracket 49 is shown securing the joined pedalboard segments (40A, 40B).

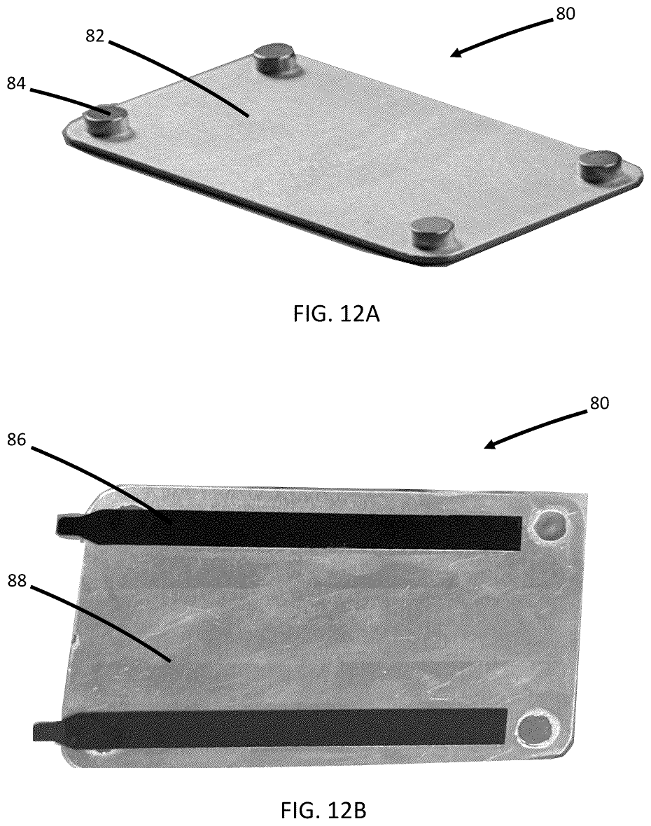

FIG. 12A is a bottom side view of a mounting plate 80 for pedal elements 16. Protruding from a bottom surface 82 of the mounting plate 80 are a set of mounting pins 84 that may be magnetic and attracted to the base layer 58. The bottom surface 82 faces away from a pedal element 16 to which it is attached to and faces toward the pedalboard mounting surface 66. The mounting pins 84 are configured to fit in the locating apertures 68 of the complementary array of locating apertures 68, and the mounting pins 84 are spaced to match the spacing of the array of locating apertures 68. FIG. 12B is a top side view of the mounting plate 80 for pedal elements 16 with adhesive strips 86 applied to a top surface 88 of the mounting plate 80 for attachment to a bottom face of a pedal element 16. The adhesive strips 86 may be removable to allow for detachment of the mounting plate 80 from a pedal element 16. It is appreciated that the dimensions of a mounting plate 80 may vary based on the dimensions of a mating surface of a pedal element 16.

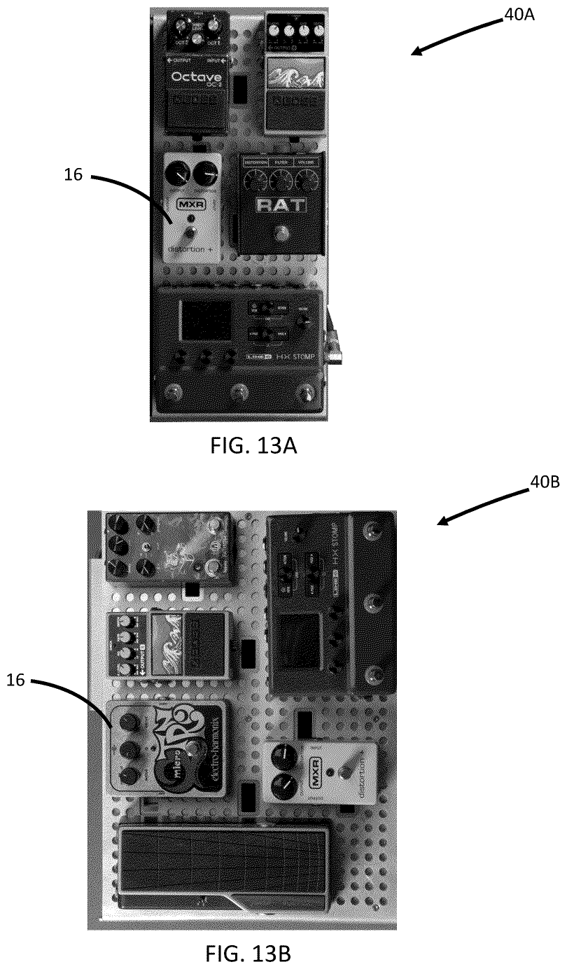

FIG. 13A and FIG. 13B illustrate examples of two sizes of pedal segments (40A, 40B) populated with pedal elements 16, respectively, that may be joined together to form a larger pedalboard.

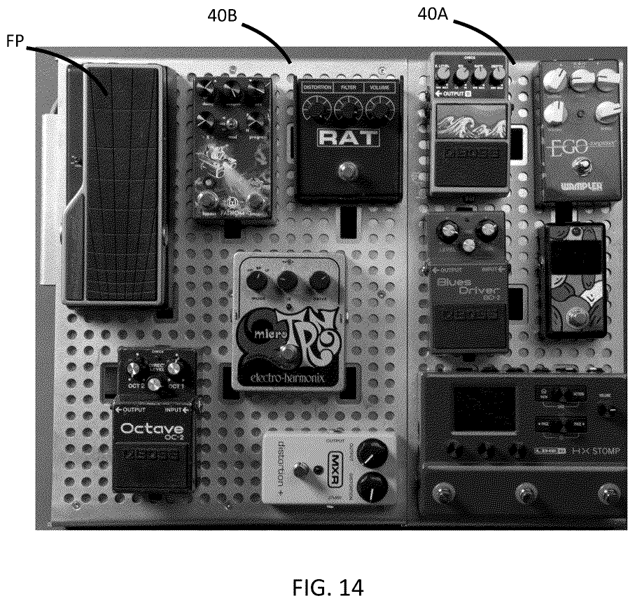

FIG. 14 illustrates an example of the two different sized pedal segments (40A, 40B) of FIGS. 13A and 13B joined together with a foot pedal FP secured in the upper left side of the pedalboard assembly.

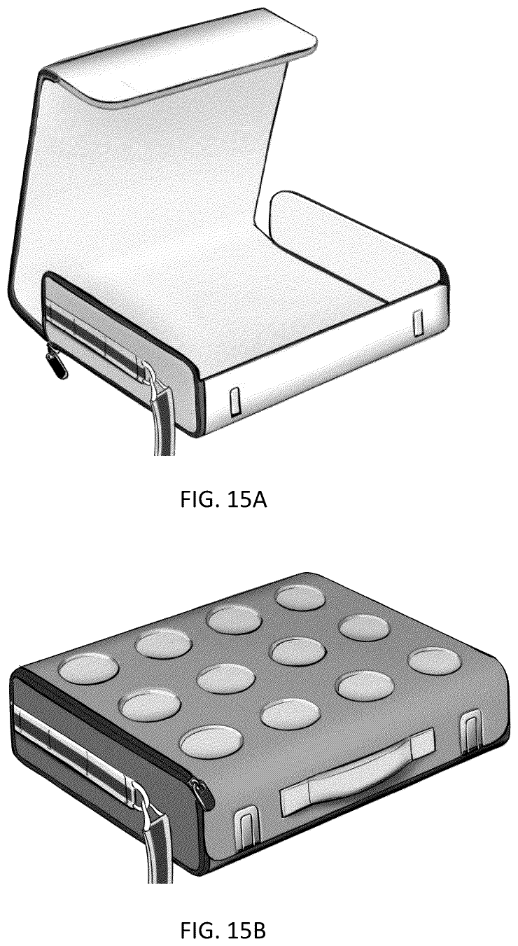

FIGS. 15A and 15B are perspective views of examples of carrying cases for the pedalboard assembly of FIG. 14. In some inventive embodiments, the case is modular and expandable in order to accommodate the various sizes of pedalboard. Both end plates of the case optionally can be detached with a zipper. Thus, additional segments can be zipped in between the two end plates so as to create an expanded, longer case.

The present invention is further detailed in the attached Appendix totaling thirty-nine pages. The contents of which are hereby incorporated by reference and synonymously refer to the inventive pedalboard assembly.

Any patents or publications mentioned in this specification are indicative of the level of those skilled in the art to which the invention pertains. These patents and publications are herein incorporated by reference to the same extent as if each individual publication was specifically and individually indicated to be incorporated by reference.

One skilled in the art will readily appreciate that the present invention is well adapted to carry out the objects and obtain the ends and advantages mentioned, as well as those inherent therein. The embodiments described herein, are exemplary, and are not intended as limitations on the scope of the invention. Changes therein and other uses will occur to those skilled in the art which are encompassed within the spirit of the invention as defined by the scope of the claims.

1. A modular pedalboard comprising:
one or more pedalboard segments, each of the pedalboard segments comprising:
a metal base layer having electrically isolated electrical contacts/connectors positioned on vertical sides of the metal base layer and a series of openings through a horizontal surface of the metal base layer; and
an outer layer that covers the horizontal surface of the metal base layer, and partially surrounds the vertical sides of the metal base layer to leave exposed the electrical contacts/connectors, the outer layer having a mounting surface with an array of locating apertures and an array of wire management apertures that align with the series of openings in the underlying metal base layer, the locating apertures adapted to hold a mounting plate attached to a bottom surface of a pedal element or a foot pedal.

2. The modular pedalboard of claim 1 wherein the outer layer is formed of brushed aluminum, plastic, composite materials, or a combination thereof.

3. The modular pedalboard of claim 1 wherein the metal base layer has connections for wire management conduits that route cables and electrical wiring.

4. The modular pedalboard of claim 1 wherein the mounting plate comprises a series of mounting pins that are adapted to fit in the array the locating apertures of the outer layer.

5. The modular pedalboard of claim 4 wherein the series of mounting pins are magnetic and are attracted to the metal base layer.

6. The modular pedalboard of claim 1 wherein the mounting plate is adhered to a pedal element with an applied adhesive pad or adhesive strips.

7. The modular pedalboard of claim 6 wherein adhesive is removable.

8. The modular pedalboard of claim 1 wherein the outer layer further comprises mating tabs, bracket magnets, and receptacles for bracket pins of a joining bracket applied to secure a plurality of pedalboard segments.

9. The modular pedalboard of claim 1 further comprising legs and feet that provide a user adjustable placement angle for one or more joined pedalboard segments.

10. The modular pedalboard of claim 1 wherein the legs or the feet attach magnetically to provide a quick change of orientation of the modular pedalboard.

11. The modular pedalboard of claim 1 wherein the metal base layer further comprises side engagement pins and side magnets on opposing vertical sides of the metal base, the side engagement pins protruding from a pedalboard segment that mate up with corresponding pin receptacles on an adjacent pedalboard segment to be joined together.

12. The modular pedalboard of claim 11 wherein the side engagement pins are magnetized.

13. The modular pedalboard of claim 1 wherein the electrical contacts/connectors on an adjacent joined pedalboard segments form a completed electrical distribution of information signals and power between the joined pedalboard segments.

14. The modular pedalboard of claim 1 wherein the series of openings and the corresponding array of wire management apertures are configured to route cables from the topside mounted pedal elements to be routed underneath the pedalboard segments.

15. The modular pedalboard of claim 1 further comprising a power supply distribution connector that routes power to multiple pedal elements via separate electrical connections.

16. The modular pedalboard of claim 1 further comprising instrument connections and other electrical connections including an external power source.

17. A kit comprising:
the modular pedalboard of claim 1; and
a modular and expandable carrying case.
